(19) United States
(12) Patent Application Publication
(10) Pub. No.: US 2025/0283792 A1
(43) Pub. Date: Sep. 11, 2025

(54) RAPID-COOLING, TEMPERATURE-INTENSIVE CRYOGENIC TEST CHAMBER ALLOWING FOR RELATIVE MOTION

(71) Applicants: The Texas A&M University System, College Station, TX (US); ATSP Innovations Inc., Houston, TX (US)

(72) Inventors: Andreas A. Polycarpou, College Station, TX (US); Louis Vaught, College Station, TX (US); Vasilis Tsigki, College Station, TX (US); Kian Bashandeh, College Station, TX (US); Pixiang Lan, Urbana, IL (US); Md Saifur Rahman, College Station, TX (US)

(73) Assignees: The Texas A&M University System, College Station, TX (US); ATSP Innovations Inc., Houston, TX (US)

(21) Appl. No.: 18/858,986

(22) PCT Filed: Apr. 25, 2023
(86) PCT No.: PCT/US2023/019765

§ 371 Date: Oct. 22, 2024

Related U.S. Application Data
(60) Provisional application No. 63/335,141, filed on Apr. 26, 2022.

(51) Int. Cl. G01N 1/42; G01N 3/18; G01N 19/02

(52) U.S. Cl. CPC G01N 1/42; G01N 3/18; G01N 19/02

(57) ABSTRACT

A cryogenic testing apparatus includes a housing in which a cryogenic chamber is positioned. An upper channel is arranged around the cryogenic chamber and is configured to receive a cryogen. A lower channel is arranged below the upper channel and is configured to receive cryogen from the upper channel. As the cryogen flows through the cryogenic testing apparatus, the cryogen contacts an exterior of the cryogenic chamber. The cryogenic chamber is unsealed and is configured to receive a gas to create positive pressure within the cryogenic chamber.

### CROSS-REFERENCE TO RELATED APPLICATIONS

This patent application claims priority from, and incorporates by reference the entire disclosure of, U.S. Provisional Patent Application No. 63/335,141 filed on Apr. 26, 2022.

### STATEMENT REGARDING FEDERALLY SPONSORED RESEARCH

This invention was made with government support under award numbers 80NSSC21C0134 and 80NSSC21C0137 awarded by NASA. The government has certain rights in the invention.

### TECHNICAL FIELD

The present disclosure relates generally to cryogenic systems and more particularly, but not by way of limitation, to methods and systems for rapidly cooling a test chamber.

### BACKGROUND

This section provides background information to facilitate a better understanding of the various aspects of the disclosure. It should be understood that the statements in this section of this document are to be read in this light, and not as admissions of prior art.

There is a major need for cryogenic testing equipment where a sample is in relative motion, such as tribological and mechanical testing (i.e., fatigue, wear, fretting, and adhesion testing). Prior systems are limited in the temperatures they can achieve. In addition, the time required to reach these limited temperatures can be 90 minutes or more, which both consumes more cryogen and limits the amount of testing that can be done.

### BRIEF DESCRIPTION OF THE DRAWINGS

A more complete understanding of the subject matter of the present disclosure may be obtained by reference to the following Detailed Description when taken in conjunction with the accompanying Drawings wherein:

FIG. 1 is a sectioned view of a cryogenic test chamber according to aspects of the disclosure;

FIG. 2 is a close-up view of a cryogenic test chamber according to aspects of the disclosure; and

FIG. 3 is a sectioned-side view of a cryogenic test chamber according to aspects of the disclosure.

### DETAILED DESCRIPTION

It is to be understood that the following disclosure provides many different embodiments, or examples, for implementing different features of various embodiments. Specific examples of components and arrangements are described below to simplify the disclosure. These are, of course, merely examples and are not intended to be limiting. The section headings used herein are for organizational purposes and are not to be construed as limiting the subject matter described. Reference will now be made to more specific embodiments of the present disclosure and data that provides support for such embodiments. However, it should be noted that the disclosure below is for illustrative purposes only and is not intended to limit the scope of the claimed subject matter in any way.

The cryogenic chambers disclosed herein are for rapidly cooling a chamber (e.g., for mechanical testing equipment) to cryogenic environmental conditions without directly exposing a test sample to cryogenic liquid coolant (known as dry testing condition). Conventional cryogenic test equipment cools a test chamber using a cryogen, such as liquid nitrogen, which acts as a heat exchanger inside the chamber to lower the surrounding temperature by expansion and evaporation. The cryogenic chambers disclosed herein flow a cryogen through a series of unconnected channels in an unsealed environment chamber at positive pressure, allowing for a large cryogen mass flow rate and improved cooling performance without requiring significant insulation or sealing. The positive pressure stops air and moisture from getting into the chamber. Positive pressure is achieved by introducing liquid cryogen and high-purity gas at room temperature into the chamber via separate feeds. The high-purity gas is introduced close to the test sample using a diffuser at room temperature, while the liquid cryogen feed is kept separate by a partition and series of diversion channels. The chamber temperature can be controlled by balancing these two flows.

The combination of separate flows of gas and liquid, a series of stationary and floating channels, and an unsealed chamber at positive pressure is a novel concept which allows for rapid, efficient, and stable cooling to a full theoretical range of temperatures (i.e., −196° C. to room temperature for liquid nitrogen). Liquid helium operation has been implemented, and is capable of cooling test equipment well below its current accurate measurement range (−200° C.).

The cryogenic chambers disclosed herein are of use for multiple applications. Their utility has been directly demonstrated for cryogenic tribology testing on tribometers. A tribometer is a machine used to measure the tribological performance of an engineering system, including friction, wear, and lubrication properties of bearing materials and lubricants. Tribological testing using a tribometer is very important in any kind of bearing material or lubricant research and development. A typical tribometer has a stationary part and a moving part that permit two testing samples to be in contact and rub against each other. Most tribometers are only capable of testing materials and lubricants under ambient environments. However, to examine the tribological performance more accurately, the best approach is to use a tribometer to simulate the actual working conditions of the materials. State-of-the-art temperature-controlled commercial tribometers can reach test temperatures of between −120° C. to −160° C.

The cryogenic chambers disclosed herein have been shown to extend the testing temperature of a typical tribometer well below this limit, using direct cooling of the testing chamber by introduction of liquid cryogens. Specifically, when using liquid nitrogen, rapid cooling has been measured at multiple sampling points to a full range of temperatures, from room temperature to −196° C.

Secondly, the cryogenic chambers disclosed herein are extremely relevant to industrial testing applications. Materials testing in a cryogenic environment is an emerging capability for storage and distribution of Liquefied Natural Gas (LNG) and refrigerants, superconductivity, and most space technologies. A few examples include the cooling systems used in Magnetic Resonance Imaging (MRI), liquid hydrogen-fueled engines, and mechanical components for future extraterrestrial NASA missions/commercial space applications. Many cryogenic materials tests, such as sliding friction, wear, fatigue life, tensile, and fracture toughness, are in high demand from public and private R&D groups, such as NASA, SpaceX, etc. The rapid and inexpensive testing capabilities that the cryogenic chambers disclosed herein offer are needed in order to develop new mechanisms, materials, and lubricants (solid, liquid, gaseous or mixtures) under extreme temperatures and controlled atmospheres. The versatile nature of the cryogenic chambers disclosed herein allow implementation in a variety of mechanical testing equipment (i.e. tensile, fatigue, fracture) where the test samples may be in relative motion.

By cooling all parts of the system in an unsealed chamber, a significantly higher coolant flowrate can be achieved, and temperatures are stable and consistent. This is done without bringing the sample into contact with the coolant. The setup is fully compatible with a heated test chamber, allowing for temperature sweep experiments (i.e., from cryogenic to extreme high temperature conditions, e.g., 1000° C.). The cryogenic chambers disclosed herein require no vacuum insulation or exotic materials, thereby decreasing cost, complexity, space required, and time required for each test. However, it is recognized that such insulation could be added to further lower the temperatures obtainable with the cryogenic chambers disclosed herein.

The cryogenic chambers disclosed herein are extremely flexible for different testing requirements and are a dramatic improvement over state-of-the-art equipment in terms of both usability and usefulness. Most cryogenic mechanical testing equipment requires large, complex, and expensive insulated environment chambers with indirect cooling, which reduces flexibility and usability.

The cryogenic liquid is fed through a direct, insulated line from a pressurized liquid tank to the test equipment, which allows the test chamber to be at positive pressure. The liquid feed line includes a vacuum-insulated part in which the cryogen remains in liquid state, and a non-vacuum-insulated section, in which partial expansion and evaporation happens. The partially-evaporated cryogen is introduced into the chamber and into a fixed, upper channel. The cryogen overflows from the upper channel and cascades into a lower channel that is in contact with a test sample holder. The lower channel is not fixed and is free to rotate and translate with the sample holder about the axis of the test chamber.

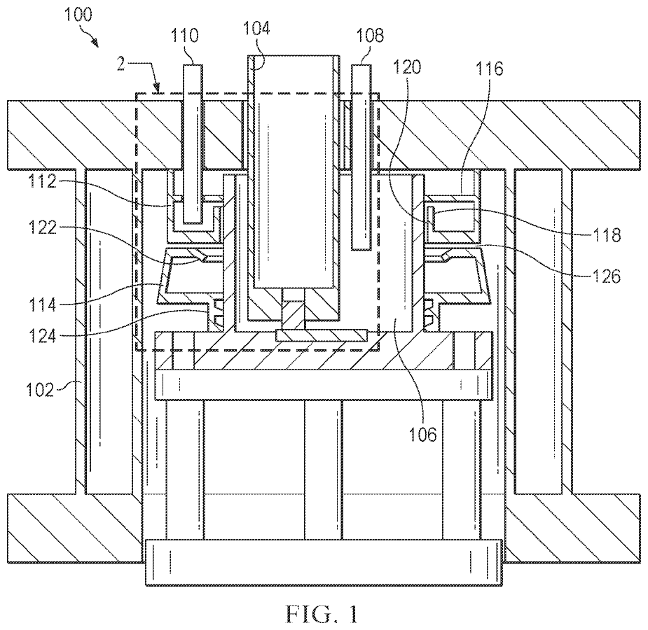

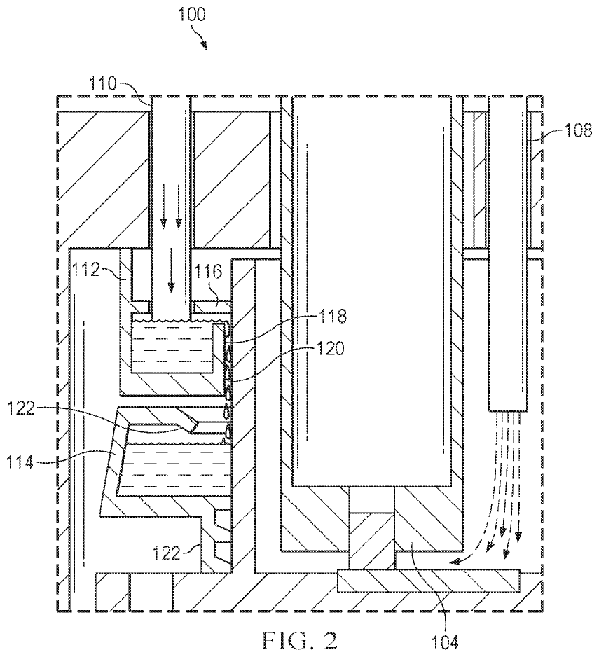

FIG. 1 is a sectioned view of a cryogenic test chamber 100 according to aspects of the disclosure. FIG. 2 is a close-up view of cryogenic test chamber 100 with cryogen and gas flowing therethrough according to aspects of the disclosure. Referring to FIGS. 1 and 2 collectively, cryogenic test chamber 100 includes a housing 102 in which testing equipment 104 is housed. Testing equipment 104 may be a tribometer or other piece of testing equipment. Testing equipment 104 sits within a chamber 106 that is temperature controlled and isolated from housing 102. A tube 108 extends into chamber 106 and delivers gas (e.g., high-purity gas at room temperature) to the volume surrounding testing equipment 104. The gas may be, for example, nitrogen, helium, methane, argon, or the like. A tube 110 extends into housing 102 and delivers cryogen to an upper channel 112. The cryogen may be, for example, liquid nitrogen, liquid helium, liquid oxygen, liquefied natural gas, or the like. Cryogen that is delivered to upper channel 112 is kept separate from chamber 106 to maintain a dry testing environment.

Upper channel 112 is ring shaped and surrounds chamber 106. An inner wall 118 of upper channel 112 is spaced slightly away from an outer wall of chamber 106 forming an annular passage 120 therebetween and allowing chamber 106 to rotate relative to upper channel 112. Cryogen is supplied to upper channel 112 via tube 110 and overflows down through annular passage 120 into a lower channel 114. Upper channel 112 includes a top wall 116 that extends over a top of wall 118 and nearly contacts the exterior of chamber 106, but is spaced apart therefrom to allow chamber 106 to rotate relative to upper channel 112. Top wall 116 nearly contacts the exterior of chamber 106 to help guide cryogen into annular passage 120. Wall 118 is dimensioned to extend almost to top wall 116, leaving a small gap for cryogen to flow out of upper channel 112 and into annular passage 120. Cryogen flows through annular passage 120 and collects in lower channel 114 (see FIG. 2).

Lower channel 114 is ring shaped and surrounds chamber 106. In some embodiments, lower channel 114 is attached to chamber 106 and rotates or translates therewith. In other embodiments, lower channel 114 is separated from chamber 106 similar to upper chamber 112. In such embodiments, it may be necessary to include a seal between chamber 106 and a base of housing 102 to prevent the cryogen from exiting housing 102 between lower channel 114 and chamber 106. A lower portion 124 of lower channel 114 acts as a seal between lower channel 114 and chamber 106 to prevent cryogen from leaking therethrough. Cryogen that sits within lower channel 114 contacts an exterior of chamber 106. Lower channel 114 includes a tapered edge 122 that helps retain cryogen within lower channel 114 and to direct any excess cryogen sitting on top of tapered edge 122 into lower channel 114 during operation of testing equipment 104. In some aspects, lower channel 114 has a tapered profile with the diameter increasing from an upper portion of lower channel 114 to a lower portion of lower channel 114.

Upper channel 112 and lower channel 114 are designed so that cryogen flowing therethrough contacts a significant portion of the exterior of chamber 106 to provide cooling thereto. Compared to prior systems, cryogenic test chamber 100 prevents cryogen from contacting testing apparatus 104. This allows for more consistent testing conditions within chamber 106.

Cryogenic test chamber 100 allows for rapid cooling compared to prior systems due to the increased mass flow rate of cryogen that is enabled as a result of the open system design (i.e., compared to a closed system design). As cryogen flows from upper channel 112 to lower channel 114, some cryogen is lost to evaporation. If too much cryogen enters cryogenic test chamber 100, excess cryogen is permitted to flow out of lower channel 114 via a radial passage 126 that is formed between upper channel 112 and lower channel 114. During normal operation, the amount of cryogen supplied to cryogenic test chamber 100 is balanced with the amount of cryogen that evaporates. This limits the amount of cryogen that spills out of the system. The increased mass flow rate afforded by cryogenic test chamber 100 increases the cooling efficiency of the system. The increase in cooling efficiency reduces the time needed to reach temperatures below −160° C., reduces the amount of cryogen needed, and enables the system to reach temperatures below that of prior systems. The instant system is also distinguished from prior systems in that it uses a gravity driven flow and does not require a pump to flow cryogen through the system.

The injection of high-purity gas at room temperature into chamber 106 provides several benefits over prior systems including better temperature control of the system and improved control of environmental conditions in chamber 106 to prevent condensation.

In various aspects, upper channel 112 and lower channel 114 may be 3D printed from various materials. The material needs only to be able to withstand the temperature of the cryogen being used. In contrast, chamber 106 is made from a material with good heat transfer properties to more efficiently cool the interior of chamber 106.

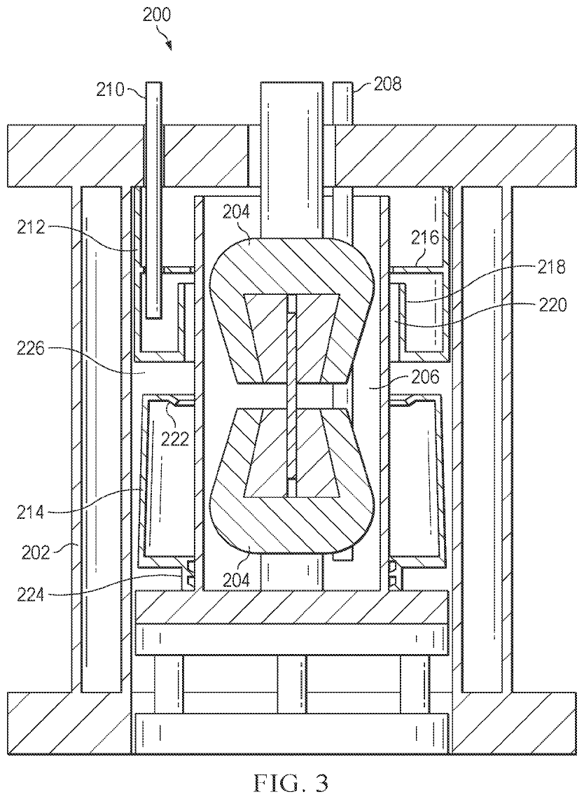

FIG. 3 is a sectioned-side view of a cryogenic test chamber 200 according to aspects of the disclosure. Cryogenic test chamber 200 is similar to cryogenic test chamber 100, and similar parts are given similar part numbers where appropriate. Cryogenic test chamber 200 is designed for use with a test apparatus 204, which is illustrated as a tensile testing machine. Cryogenic test chamber 200 includes a housing 202 configured to house a chamber 206, an upper channel 212, and a lower channel 214. Chamber 206 is configured to surround test apparatus 204. A tube 208 extends into chamber 206 and delivers gas (e.g., high-purity gas at room temperature) to chamber 206. A tube 210 extends into housing 202 and delivers cryogen to upper channel 212. Upper channel 212 includes a top wall 216 that helps retain cryogen and direct the flow of cryogen from upper channel 212 to lower channel 214 via an annular passage 220 formed between a wall 218 of upper channel 212 and an outer wall of chamber 206. Lower channel 214 includes a tapered edge 222 that helps retain cryogen within lower channel 214 and to direct any excess cryogen sitting on top of tapered edge 222 into lower channel 214 during operation of testing equipment 204. In some aspects, lower channel 214 has a tapered profile with the diameter increasing from an upper portion of lower channel 214 to a lower portion of lower channel 214. If too much cryogen enters cryogenic test chamber 200, excess cryogen is permitted to flow out of lower channel 214 via a radial passage 226 that is formed between upper channel 212 and lower channel 214. A key difference between chambers 100 and 200 are the dimensions. In the embodiment of FIG. 3, upper channel 212 and lower channel 214 are longer in the axial direction to accommodate the dimensions of chamber 206. Apart from dimensional differences, the chambers 100 and 200 are similar and operate in a similar manner.

### Experimental Testing

Testing with liquid nitrogen demonstrated rapid cooling performance. Prior to implementation of the cryogenic chambers disclosed herein, a tribometer was capable of reaching an equilibrium temperature of −150° C. in 90 minutes using metered nitrogen flow to avoid flooding the chamber. The instant design allows the system to reach a temperature of −196° C. after 7 minutes of nitrogen burst flow. This cooling performance has been robustly validated using cryogenic probes configured to sample the chamber atmosphere, near-contact, and contact temperatures. Beyond a performance improvement, cryogen consumption is also reduced due to the dramatic reduction in cooling time per testing cycle. The ultra-fast cooling down to cryogenic temperatures is achieved by an initial burst of cool nitrogen gas inside the chamber, until the chamber temperature is sufficiently cold in dry state (no moisture or other contaminants from ambient air, as determined by gas detectors) for the introduced cryogen, for example nitrogen, to be liquid phase. This liquid is kept separate from the test sample, but is brought into direct contact with an exterior face of the sample holder. Thus, heat absorption and evaporation happen inside the innermost testing volume independent of the phase change, and, consequently, the temperature can be further lowered. The continuous introduction of a balance of mixed-phase, or liquid and gaseous coolant into the test environment and past the sample holder ensures that, despite using an unsealed chamber, the test atmosphere is well-controlled and testing is performed in a dry condition.

### Working Examples

Two identical specimens were tensile tested at room temperature and at −150° C. using a cryogenic test chamber according to aspects of the disclosure. The first specimen was loaded into the tensile testing machine and tensile tested at room temperature. The second specimen was loaded into the tensile testing machine, the cryogenic test chamber was used to cool the second specimen to −150° C., and then the second specimen was tensile tested. The cooling process took approximately 2 minutes and 29 seconds (as compared to around 40 minutes for other testing machines). Table 1 below illustrates results of the tensile testing.

TABLE 1
Tensile Testing Results

| | | Tensile | Tensile | | Tensile | Tensile | |
|---|---|---|---|---|---|---|---|
| | | Stress at | Stress at | Load at | Stress at | Strain at | Tensile |
| | Maximum | Maximum | Maximum | Break | Break | Break | Stress |
| | Load | Load | Load | (Standard) | (Standard) | (Standard) | Yield |
| | (N) | (MPa) | (%) | (N) | (MPa) | (%) | (MPa) |
| First | 302.27 | 46.03 | 439.72 | 10.65 | 1.62 | 451.25 | 46.03 |
| Specimen | | | | | | | |
| (Room | | | | | | | |
| Temp.) | | | | | | | |
| Second | 871.94 | 132.79 | 471.05 | 871.94 | 132.79 | 471.05 | 132.79 |
| Specimen | | | | | | | |
| (−150° C.) | | | | | | | |

Although various embodiments of the present disclosure have been illustrated in the accompanying Drawings and described in the foregoing Detailed Description, it will be understood that the present disclosure is not limited to the embodiments disclosed herein, but is capable of numerous rearrangements, modifications, and substitutions without departing from the spirit of the disclosure as set forth herein.

The term “substantially” is defined as largely but not necessarily wholly what is specified, as understood by a person of ordinary skill in the art. In any disclosed embodiment, the terms “substantially”, “approximately”, “generally”, and “about” may be substituted with “within [a percentage] of” what is specified, where the percentage includes 0.1, 1, 5, and 10 percent.

The foregoing outlines features of several embodiments so that those skilled in the art may better understand the aspects of the disclosure. Those skilled in the art should appreciate that they may readily use the disclosure as a basis for designing or modifying other processes and structures for carrying out the same purposes and/or achieving the same advantages of the embodiments introduced herein. Those skilled in the art should also realize that such equivalent constructions do not depart from the spirit and scope of the disclosure, and that they may make various changes, substitutions, and alterations herein without departing from the spirit and scope of the disclosure. The scope of the invention should be determined only by the language of the claims that follow. The term “comprising” within the claims is intended to mean “including at least” such that the recited listing of elements in a claim are an open group. The terms “a”, “an”, and other singular terms are intended to include the plural forms thereof unless specifically excluded.

Conditional language used herein, such as, among others, “can”, “might”, “may”, “e.g.”, and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, the processes described herein can be embodied within a form that does not provide all of the features and benefits set forth herein, as some features can be used or practiced separately from others. The scope of protection is defined by the appended claims rather than by the foregoing description. All changes which come within the meaning and range of equivalency of the claims are to be embraced within their scope.

Although various embodiments of the method and apparatus of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth herein.

1. A cryogen test chamber comprising:
a chamber;
an upper channel surrounding the chamber and configured to receive cryogen, wherein the upper channel is not connected to the chamber so that the chamber can move relative to the upper channel; and
a lower channel surrounding the chamber.

2. (canceled)

3. The cryogen test chamber of claim 1, wherein the lower channel is connected to the chamber and rotates therewith.

4. The cryogen test chamber of claim 1, further comprising an annular passage formed between an inner wall of the upper channel and an exterior wall of the chamber.

5. The cryogen test chamber of claim 4, wherein the upper channel comprises a top wall that extends over a top of the inner wall.

6. The cryogen test chamber of claim 1, wherein the lower channel comprises a top wall with a tapered edge.

7. The cryogen test chamber of claim 1, further comprising a first tube that supplies cryogen and a second tube that supplies gas.

8. The cryogen test chamber of claim 7, wherein the first tube extends into the first channel.

9. The cryogen test chamber of claim 7, wherein the second tube extends into the chamber.

10. The cryogen test chamber of claim 1, further comprising a testing apparatus disposed within the chamber.

11-19. (canceled)

20. A method of cooling a cryogen test chamber, the method comprising:
directing a flow of a cryogen through a first channel and a second channel so that the cryogen contacts an outer wall of the chamber; and
directing a flow of gas into the chamber to create a positive relative within the chamber,
wherein the chamber is unsealed.

21. The method of claim 20, further comprising operating a testing apparatus that is positioned within the chamber.

22. The method of claim 20, wherein the first channel is not coupled to the chamber so that the chamber may rotate relative to the first channel.

23. The method of claim 20, wherein the lower channel is connected to the chamber and rotates therewith.

24. The method of claim 20, further comprising an annular passage formed between an inner wall of the upper channel and an exterior wall of the chamber.

25. The method of claim 24, wherein the upper channel comprises a top wall that extends over a top of the inner wall.

26. The method of claim 20, wherein the lower channel comprises a top wall with a tapered edge.

27. The method of claim 20, further comprising a first tube that supplies cryogen and a second tube that supplies gas.

28. The method of claim 27, wherein the first tube extends into the first channel.

29. The method of claim 27, wherein the second tube extends into the chamber.

30. The method of claim 20, further comprising a testing apparatus disposed within the chamber.
